(19) United States
(12) Patent Application Publication
(10) Pub. No.: US 2004/0073503 A1
(43) Pub. Date: Apr. 15, 2004

(54) Method and system for managing and processing service requests

(76) Inventors: Ramon Morales, North Bergen, NJ (US); James Napolitano, Basking Ridge, NJ (US); William Dodge, Atlantic Highlands, NJ (US)

Correspondence Address: PILLSBURY WINTHROP, LLP, P.O. BOX 10500, MCLEAN, VA, 22102, US

(21) Appl. No.: 10/270,249

(22) Filed: Oct. 15, 2002

(51) Int. Cl. G06F 17/60

(52) U.S. Cl. 705/35

(57) ABSTRACT

In accordance with various embodiments of the invention, a system and various methodologies are provided that enable proactive analysis of details associated with clients' financial services transactions by the organization(s) providing those services. Additionally, the system and various methodologies generate automated electronic messages that are transmitted to clients to inform them of potential issues effecting their financial service transactions. These automated electronic messages may be reviewed by clients in a secure environment and responded to by the clients with the goal of resolution of identified potential issues.

### BACKGROUND OF THE INVENTION

A portion of the disclosure of this patent document contains material which is subject to copyright protection. The copyright owner has no objection to the facsimile reproduction by any one of the patent disclosure, as it appears in the Patent and Trademark Office patent files or records, but otherwise reserves all copyright rights whatsoever.

1. Field of the Invention

The present invention relates to the field of electronically managing and processing service requests and more particularly financial service requests.

2. Description of Related Art

Consumers routinely make payments to utilities, merchants and service providers by check. In such a transaction, the check is submitted in return for goods and/or services. That check is then endorsed by the receiver of the check, endorsed and submitted to a financial institution to trigger payment of associated funds from the consumer to the product or service provider.

Over the last few years, many consumers have begun to take advantage of automated bill payment services that allow them to pay recurring bills automatically without having to right a check. In such bill payment services, bills may be paid to a creditor using funds included in one or more accounts or credit funds provided by one or more credit card accounts information indicating what bills are to be paid, for what period of time and other associated information is provided by an individual to an organization that provides bill payment services. Additionally, the creditor may be informed that a bill payment service will be used to pay recurring bills to the creditor, for example, if bills are to be submitted directly to the bill payment service. Subsequently, the bill payment service handles payment of the recurring bills until the authorized time period expires. Such bill payment services may simply be stand alone service providers; alternatively, the bill payment service may be merely one service offered by a financial institution, organization or credit card company

Similarly, many individuals utilize a service known conventionally as an “electronic funds transfer.” Electronic funds transfers are routinely used by financial institutions and are now also routinely used by individuals. Broadly speaking, an electronic funds transfer is the depositing, transferring, or dispensing of funds electronically. Hence, a direct deposit of a paycheck is an electronic funds transfer as is the wiring of money from one individual to another. Electronic funds transfers can be even more commonplace in certain financial arenas including stock, bond and other financial instrument trading.

### SUMMARY OF THE INVENTION

In accordance with various embodiments of the invention, a system and various methodologies are provided that enable proactive analysis of details associated with clients' financial services transactions by the organization(s) providing those services. Additionally, the system and various methodologies generate automated electronic messages that are transmitted to clients to inform them of potential issues effecting their financial service transactions. These automated electronic messages may be reviewed by clients in a secure environment and responded to by the clients with the goal of resolution of identified potential issues.

### BRIEF DESCRIPTION OF THE DRAWINGS

Various embodiments of this invention will be described in detail, with reference to the following figures, wherein:

FIG. 1 illustrates an example of a hardware configuration that may be used for a client to access a system designed in accordance with at least one embodiment of the invention;

FIG. 2 illustrates an example of a client terminal that may be utilized in Conjunction with at least one embodiment of the invention;

FIG. 3 illustrates one example of a potential page flow that may be displayed to clients as they navigate a web-site associated with a system designed in accordance with at least one embodiment of the invention;

FIG. 4 illustrates details of a screen flow associated with bill payment and electronic funds transfer history inquiries in accordance with at least one embodiment of the invention;

FIG. 5 illustrates an example of the “Overview” page;

FIG. 6 illustrates an example of the “Service Request/Client Service” Home page;

FIG. 7 illustrates an example of a “Read Message” page;

FIG. 8 illustrates an example of a “Follow Up Message” page;

FIG. 9 illustrates an example of a “Send Message” page;

FIG. 10 illustrates an example of a “Send Confirmation” page;

FIG. 11 illustrates an example of a “Bill Payment History Summary” page;

FIG. 12 illustrates an example of a “Bill Payment History Details” page;

FIG. 13 illustrates an example of a “Bill Payment History Inquiry” page;

FIG. 14 illustrates an example of a “Bill Payment History Inquiry Confirmation” page;

FIG. 15 illustrates an example of a “Funds Transfer History Summary” page;

FIG. 16 illustrates an example of a “Funds Transfer History Details” page;

FIG. 17 illustrates an example of a “Funds Transfer History Inquiry” page; and

FIG. 18 illustrates an example of a “Funds Transfer History Inquiry Confirmation” page.

### DETAILED DESCRIPTION OF EMBODIMENTS OF THE INVENTION

With individuals' growing acceptance and familiarity with electronic bill payment and electronic funds transfer services, the number of individuals using these services continues to increase. Additionally, many of these individuals are actively managing multiple accounts, requesting services and transactions that affect more than one of their accounts. Thus, the number and complexity of service transactions to be managed by an organization providing such financial services has increased significantly.

As in any organization processing transactions, there are bound to be transactions and periods of time that are unusual or require extra attention on the part of the service organization personnel or the individual requesting the financial services provided by that organization. Thus, identifying such transactions and periods of time is useful to all parties involved in such transactions because it allows the services to be provided effectively. Accordingly, a great deal of utility is provided by developing a computer system that effectively handles such transactions as well as identifies issues associated with such transactions and Facilitates resolution of these issues.

Thus, in accordance with at least one embodiment of the invention, a system is provided that allows clients of an organization associated with the system to utilize online bill payment and electronic funds transfer services provided by that organization as well as to send and receive text inquiries to and from the organization regarding the services and service transactions via a secure connection.

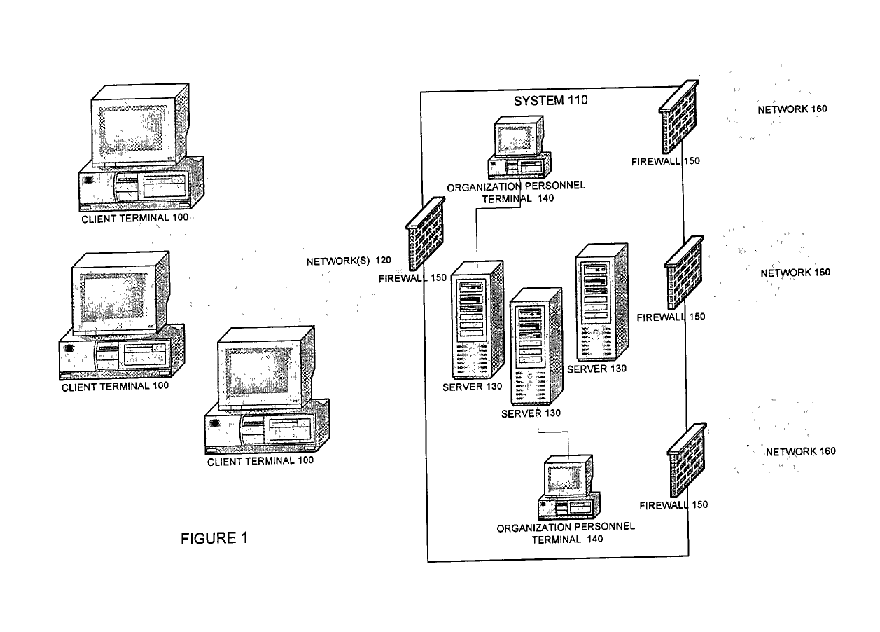

FIG. 1 illustrates an example of a hardware configuration that may be used for a client to access a system designed in accordance with at least one embodiment of the invention. As illustrated in FIG. 1, the client may utilize a client terminal 100 that is optionally coupled to the system 110 via a secure connection established using a conventionally known technology, for example, secure sockets layer, password protected entry to the system 110, a dedicated link, or any other available technology. This connection between the system 110 and the client terminal 100 may be via one or more network(s) 120, which may be comprised of a POTS network, a digital network, a wireless network, or any combination thereof. As is shown in FIG. 1, multiple client terminals 100 may be coupled to the system 110 at any given time. Each of these client terminals 100 may correspond to a particular client of the system and/or organization providing the financial services.

The system 110 may include one or more servers 130 coupled together and operating to support, manage and process financial services for the clients. Such servers 130 may run software configured to provide various financial services to the clients. Additionally, the software running on the servers 130 may be configured to monitor processing of associated financial service transactions and, based on that monitoring, proactively analyze whether there are any obstacles to completing the financial services transactions, e.g., necessary paperwork not submitted, outstanding checks, the end of a transaction authorization. Further, the serves 130 may include or be coupled to memory for storing data associated with financial services, transactions and processing thereof.

The system may also include one or more system organization personnel terminals 140 configured to allow organization personnel associated with the operation of the system to interact with system components and clients to facilitate both requested financial services and messaging with clients regarding such services. Additionally, the system may include one or more firewalls 150 that provides some measure of security for the system 110 to help ensure that unauthorized entry from the network 120 or other network 160 coupled to the system could occur. Alternatively, or in addition, other security mechanisms may also be utilized to ensure data integrity and security for the system 110. The one or more additional networks 160 may include dedicated links and private and public networks that are used to provide the financial services with which the system is associated, e.g., electronic funds transfers, bill payments, check processing, etc.

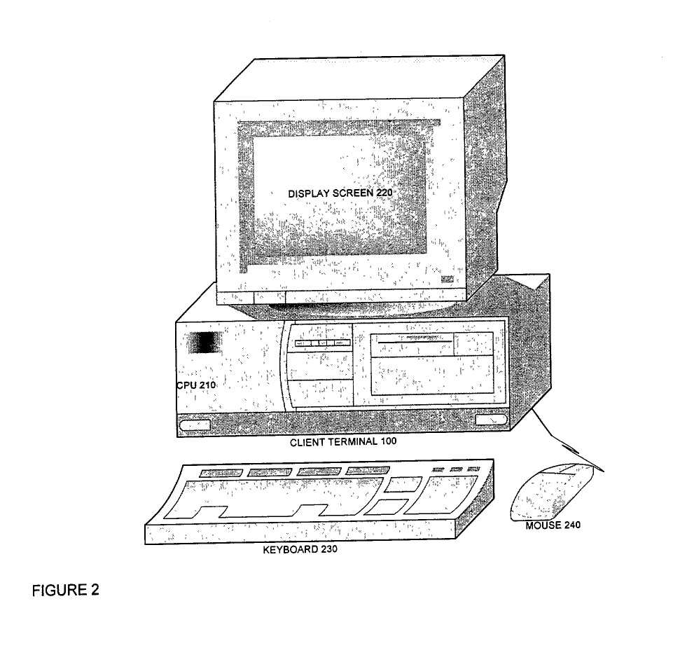

FIG. 2 illustrates an example of a client terminal 100 which includes, for example, a Central Processing Unit (CPU) 210, a display screen 220, a keyboard 230 and a mouse or other pointing device 240. It should be understood that the client terminal 100 may be implemented using a personal computer, workstation, laptop or specialized computer; alternatively, the client terminal 100 may be implemented in whole or in part using a personal data assistant, pocket personal computer, mobile telephone or any device providing functionality allowing a client to be connected to the system 110, to view pages of data associated with the system (explained in detail herein) and to interact with the system 110 by using some type of user interface (e.g., in FIG. 2, the combination of the display screen 220, the keyboard 230 and the pointing device 240.

Clients that log into the system providing the financial services can read messages related to their requested services by clicking on a “Service Requests/Client Services” link on a web-page included in a web-site associated with the system and/or services. Clients may also be alerted of “New” messages from the system and/or organization associated with the system via a dedicated link on an “Overview” page, which may be the first page presented to clients when they are logging into the system. Clients can either read and/or reply to messages they have received from the system and/or the organization associated with the system. Clients can initiate transmission of messages to the system and/or the organization associated with the system from this page. They can also initiate messages to the system and/or the organization associated with the system from the “Bill Payment” or “Funds Transfer History Details” pages. Messages initiated from these pages may include the details of the service transaction the inquiry is based upon. Thus, the client need not manually enter transaction details.

In accordance with at least one embodiment of the invention, messages sent from clients may be researched and responded to first by personnel who are responsible for overseeing client account operations. These personnel may draft a response to a client's (generated message and the response may then be automatically forwarded to personnel associated with client service, which may review the response and transmit the message reply to the client. Client operations personnel may also have the ability to initiate transmission of messages directly to clients. Such messages may also be reviewed by client service personnel prior to being sent to clients.

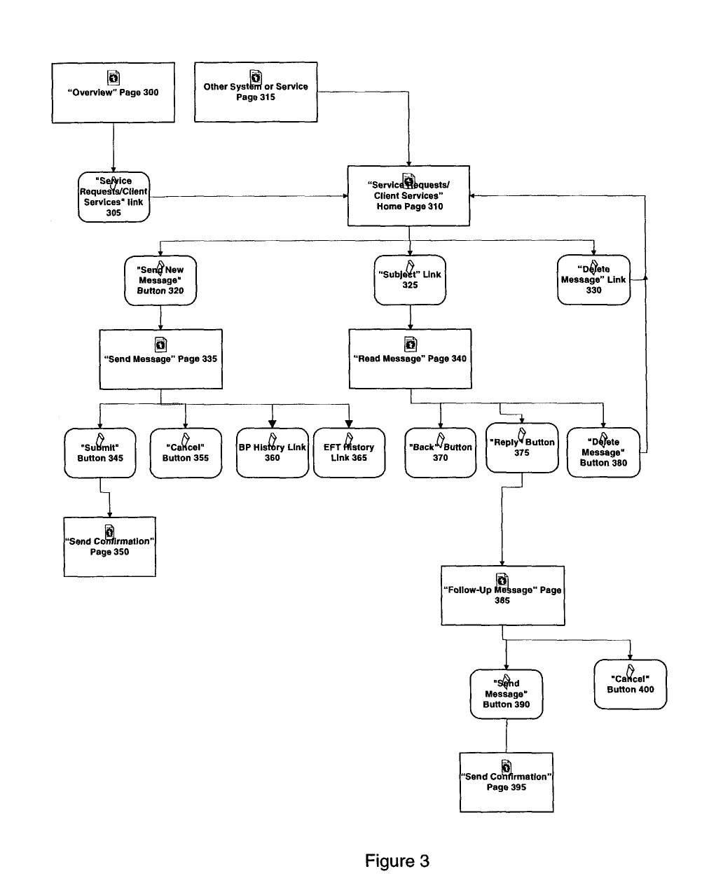

FIG. 3 illustrates one example of a potential screen flow or page flow of screens or pages (hereafter referred to as pages) that may be displayed to clients as they navigate a web-site associated with the system. As illustrated in FIG. 3, display may begin with, for example, an “Overview” page 300 that may be the first page displayed to the client following entry of necessary information to authenticate the client's identity (e.g., a client name and password). While the “Overview” page 300 is displayed, a client clicking on a “Service Requests/Client Services” link displayed on that page may trigger display of a “Service Requests/Client Services” home page 310. This page 310 may also be reached by a client from another page, e.g., one associated with the system or a page 315 associated with, for example, another service offered by the system or another system.

The “Service Requests/Client Services” page displays the headers for all of the client's messages and associated links to view the details of each message. Thus, once the “Service Requests/Client Services” home page 310 is displayed, a client may click on various links and/or icons displayed on that page to navigate to additional pages. For example, clicking on a “Send Message” button 320 will trigger display of a “Send Message” page 335. Similarly, clicking on a “Subject” link 325 for any one of the messages will trigger display of a “Read Message” page 340 that will display the text and other details of the associated message. A client clicking on a “Delete Message” link 330 will trigger both deletion of the message from a new mail folder or account associated with the client and potentially trigger refreshing of the “Service Requests/Client Services” home page 310 without display oil information associated with the deleted message.

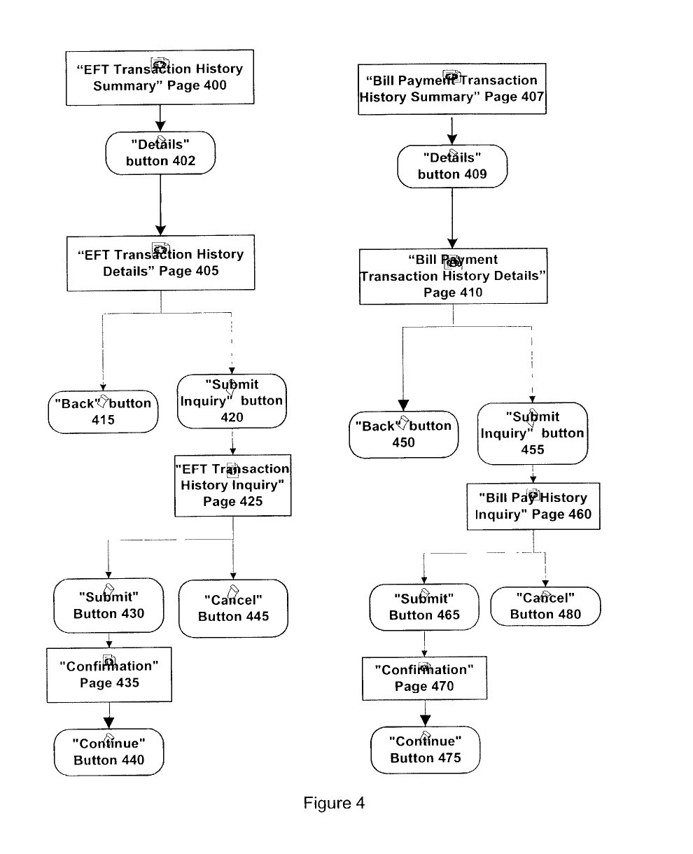

While the “Send Message” page 335, mentioned above, is displayed, a client may click on various icons and buttons including a “Submit” button 345, a “Cancel” button 355, a “BP History” link 360, and an “EFT History” link 365. The “Submit” button 345 may be clicked for example, after a client has composed a message or response to a message and wishes to trigger transmission of the message. Clicking on the “Submit” button 345 will trigger display of a “Send Confirmation” page 350 that will include confirmation that the message has been sent to the recipient, for example, personnel associated with the system and/or the organization providing financial services using the system. The text on the “Send Confirmation” page 395 may be specific to the subject selected for the message (as explained in detail herein). The “Cancel” button 355 may be clicked, for example, if a client has decide not to send such a message. Clicking the “Cancel” button will trigger display of the “Service Requests/Client Services” home page 310 without a message being transmitted. A client clicking on the “BP Hlistory” link 360 will trigger display of the “Bill Payment History Summary” page (as explained herein with reference to FIG. 4). Similarly, a client clicking on the “EFT History” link 365 will trigger display of the “Electronic Funds Transfer History Summary” page (as explained herein with reference to FIG. 4).

While the “Read Message” page 340, mentioned above, is displayed, a client may click on various icons and buttons including a “Back” button 370, a “Reply” button 375 or a “Delete Message” button 380. If the “Back” button 370 is clicked by the client, the message being read will be saved in a folder or account associated with the client and the status associated with that message on the “Service Requests/Client Services” home page 310 subsequently will be updated. If the “Reply” button 375 is clicked by the client, display of a “Follow-Up Message” page 385 will be displayed. The “Follow-Up Message” page 385 allows a client to compose a follow-up message associated with the most recently displayed message to the client. However, in at least one embodiment of the invention, the client cannot compose or transmit follow-up messages to received messages that were sent globally to all or some portion of clients. Additionally, the client may not be allowed to compose or transmit follow-up messages to previously sent messages. Nevertheless, while the “Follow-Up Message” page 385 is displayed, a client may compose a follow-up message and, when wishing to transmit the composed message by clicking on a “Send Message” button 390 displayed on the “Follow-Up Message” page 385. Following clicking of the “Send Message” button 390, a “Send Confirmation” page 395 will be displayed, which indicates confirmation that the message has been sent to the recipient, for example, personnel associated with the system and/or the organization providing financial services using the system. The text on the “Send Confirmation” page 395 may be specific to the subject selected for the message (as explained in detail herein. Alternatively, clicking the “Cancel” button will trigger display of the “Read Message” page 340 without a message being transmitted.

FIG. 4 illustrates additional detail of screen flow associated with both the bill payment and electronic funds transfer history inquiries. As explained above with reference to FIG. 3, the “Electronic Funds Transfer History Summary” page 400 may be displayed as a result of a client clicking on the “EFT History” link. Similarly, the “Bill Payment History Summary” page 407 may be displayed as a result of a client clicking on the “BP History” link.

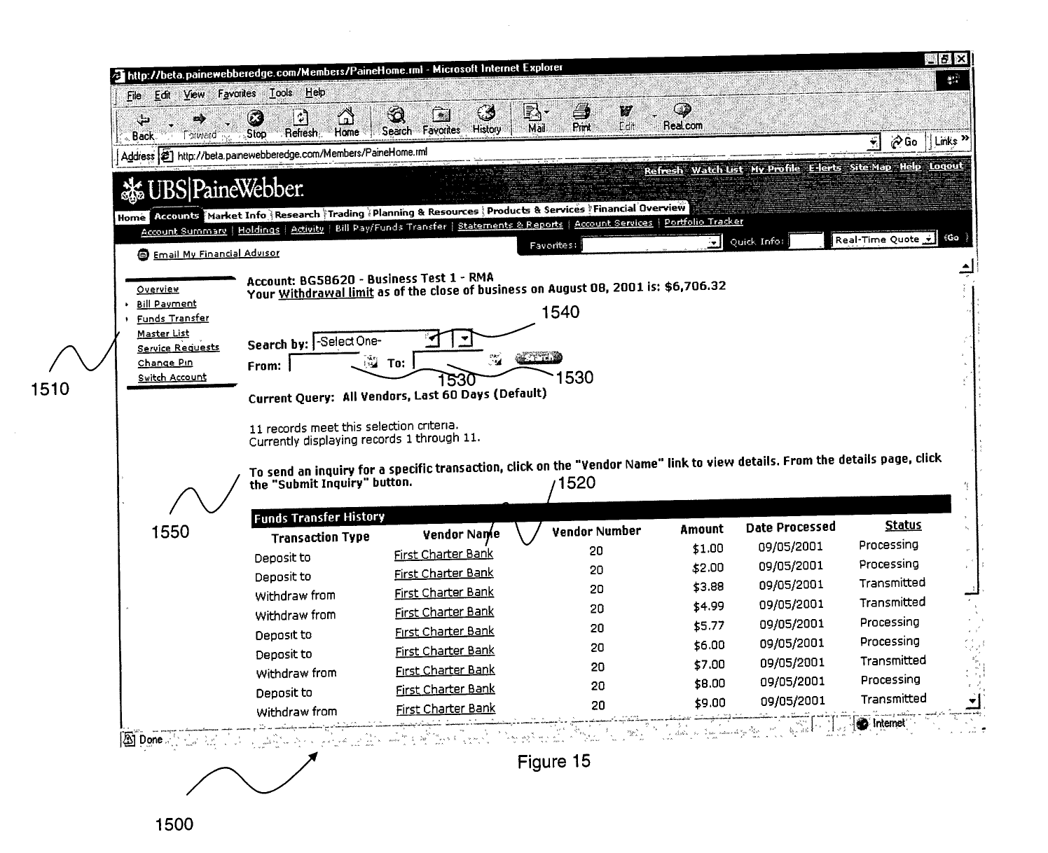

While the “Electronic Funds Transfer History Summary” page is displayed, a client can click on a “Details” button 402 to trigger display of an “Electronic funds Transfer History Details” screen 405. Once the “Electronic Funds Transfer History Details” page 405 is displayed, a client can view details associated with a particular electronic funds transfer transaction. Subsequently, the client can click on a “Back” button 415 that triggers display of “Electronic Funds Transfer History Summary” page (an example of which being illustrated in FIG. 15), which displays multiple information associated with all or more than one of the electronic finds transfer transactions of the client. Alternatively, the client can click on a “Submit Inquiry” button 420 displayed on the page, which will trigger display of an “Electronic Funds Transfer History Inquiry” page 425. This page 425 is configured to include pertinent transaction details within the body of an inquiry message that the client can compose on the page 425. While displaying page 425, and after the inquiry message is composed, the client can click on a “Submit” button 430, which will trigger display of a “Confirmation” page 435. This page 435 will indicate that the inquiry has been transmitted to the recipient, for example, personnel associated with the system and/or the organization providing financial services using the system. Subsequently, an indication that the inquiry message was sent may also be displayed on the “Service Request/Client Service” Home page 310 (see FIG. 3). The text on the “Confirmation” page 435 may be specific to the subject selected for the message (as explained in detail herein). While page 435 is displayed, the client may click on a “Continue” button 440 that will trigger display of the “Electronic Funds Transfer History Summary” page (an example of which being illustrated in FIG. 15). Alternatively, rather than clicking on the “Submit” button 435, the client clicking the “Cancel” button 445 will trigger display of the “Electronic Funds Transfer History” page without a message being transmitted.

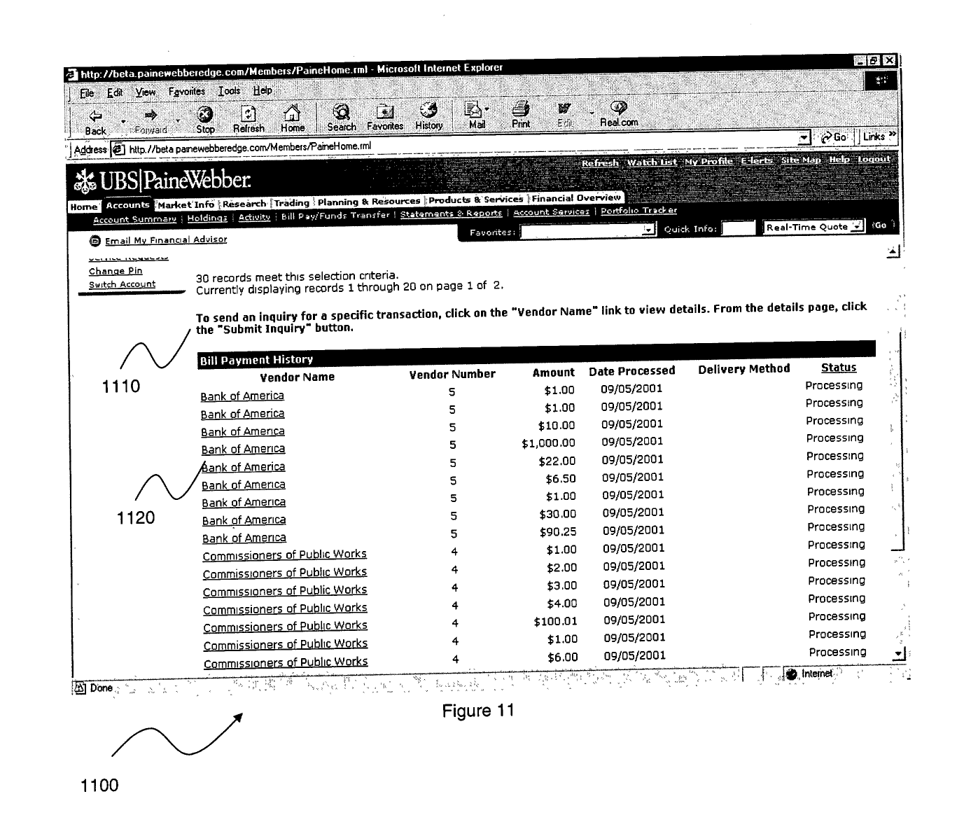

While the “Bill Payment History Summary” page 407 is displayed, a client can click on a “Details” button 409 to trigger display of a “Bill Payment History Details” screen 410. When the “Bill Payment History Details” page 410 is displayed, a client can view details associated with a particular bill payment transactions. Subsequently, the client can click on a “Back” button 450 that triggers display of “Bill Payment History Summary” page 407 (an example of which being illustrated in FIG. 11), which displays multiple information associated with all or more than one of the bill payment transactions of the client. Alternatively, the client can click on a “Submit Inquiry” button 455 displayed on the page, which will trigger display of an “Bill Payment History Inquiry” page 460. This page 460 is configured to include pertinent transaction details within the body of an inquiry message that the client can compose on the page 460. While displaying page 460, and after the inquiry message is composed, the client can click on a “Submit” button 465, which will trigger display of a “Confirmation” page 470. This page 470 will indicate that the inquiry has been transmitted to the recipient, for example, personnel associated with the system and/or the organization providing financial services using the system. Subsequently, an indication that the inquiry message was sent may also be displayed on the “Service Request/Client Service” Home page 310 (see FIG. 3). The text on the ““Confirmation” page 470 may be specific to the subject selected for the message (as explained in detail herein). While page 470 is displayed, the client may click on a “Continue” button 475 that will trigger display of the “Bill Payment History Summary” page (an example of which being illustrated in FIG. 11). Alternatively, rather than clicking on the ““Submit” button 470, the client clicking the “Cancel” button 480 will trigger display of the “Bill Payment History Summary ” page without a message being transmitted.

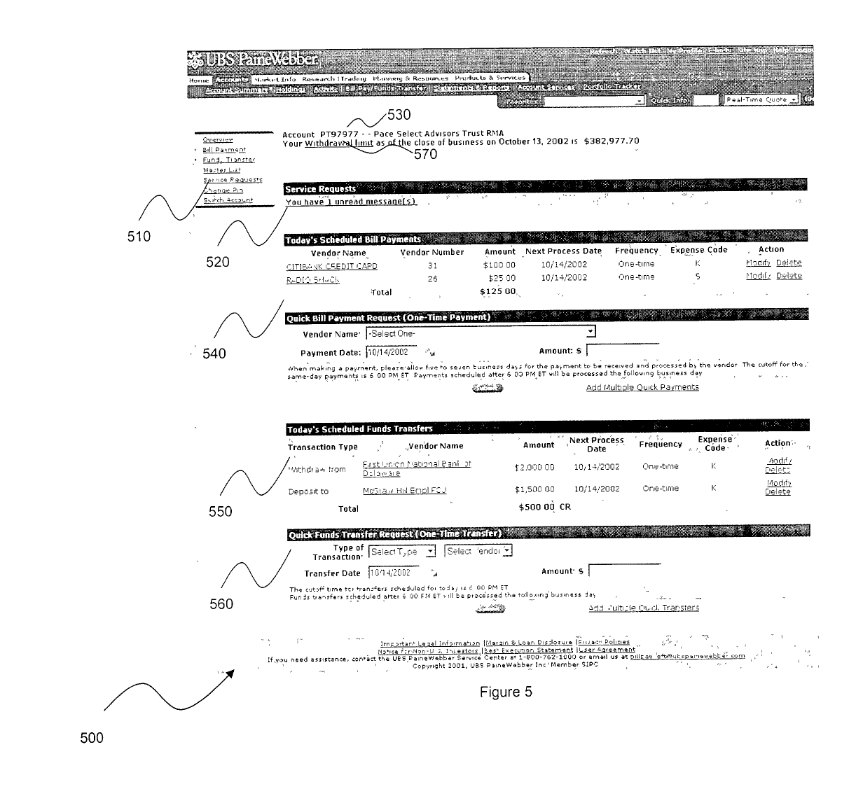

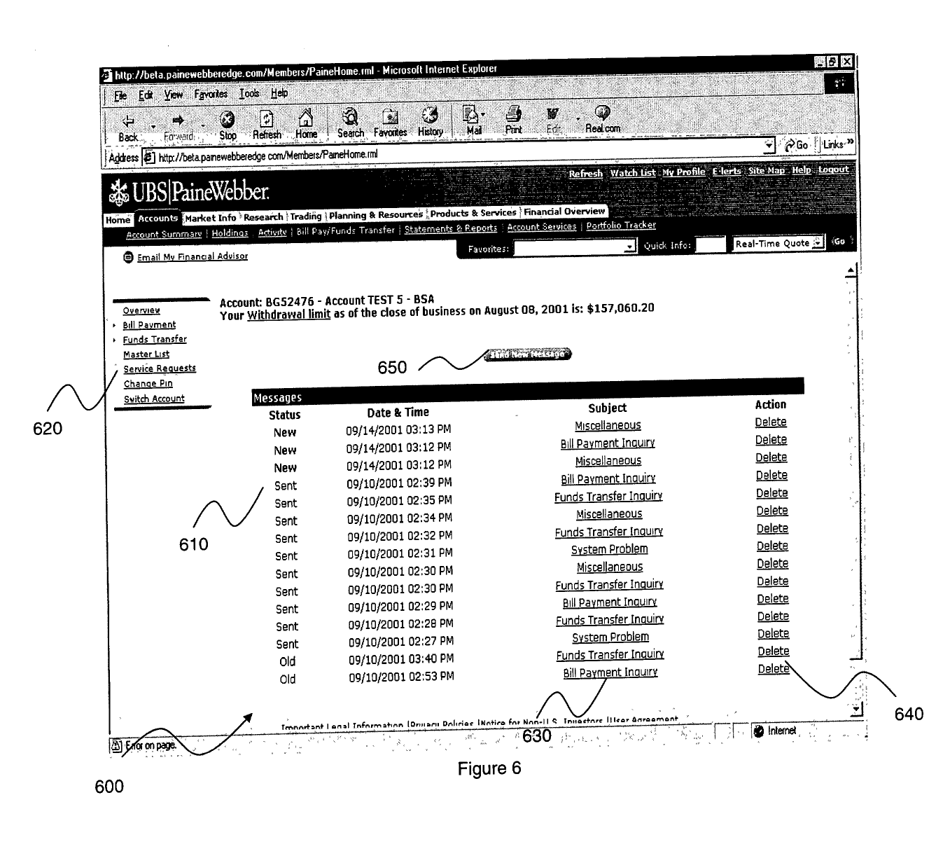

FIG. 5 illustrates an example of the “Overview” page 500 that, as explained above, may be the initial page that is displayed after a client logs on to the system. From this page, a client clicking on the “Service Requests” link 510 triggers display of the “Service Request/Client Service Home” page (an example of being illustrated in FIG. 6). A client clicking on the “You have X unread message(s)” link 520 also triggers display of the “Service Request/Client Service Home” page. If there are no unread messages, the “You have X unread messages” link 520 may not be displayed on the pages. As illustrated in FIG. 5, the “Overview” page 500 may display various information including, for example, a client's account number 530, a current day's list of bill payments and associated details 540, the current day's list of funds transfers and associated details 550, information allowing a client to make one time funds transfers 560 and a link 570 that allows a client to view information regarding their withdrawal limit from that account.

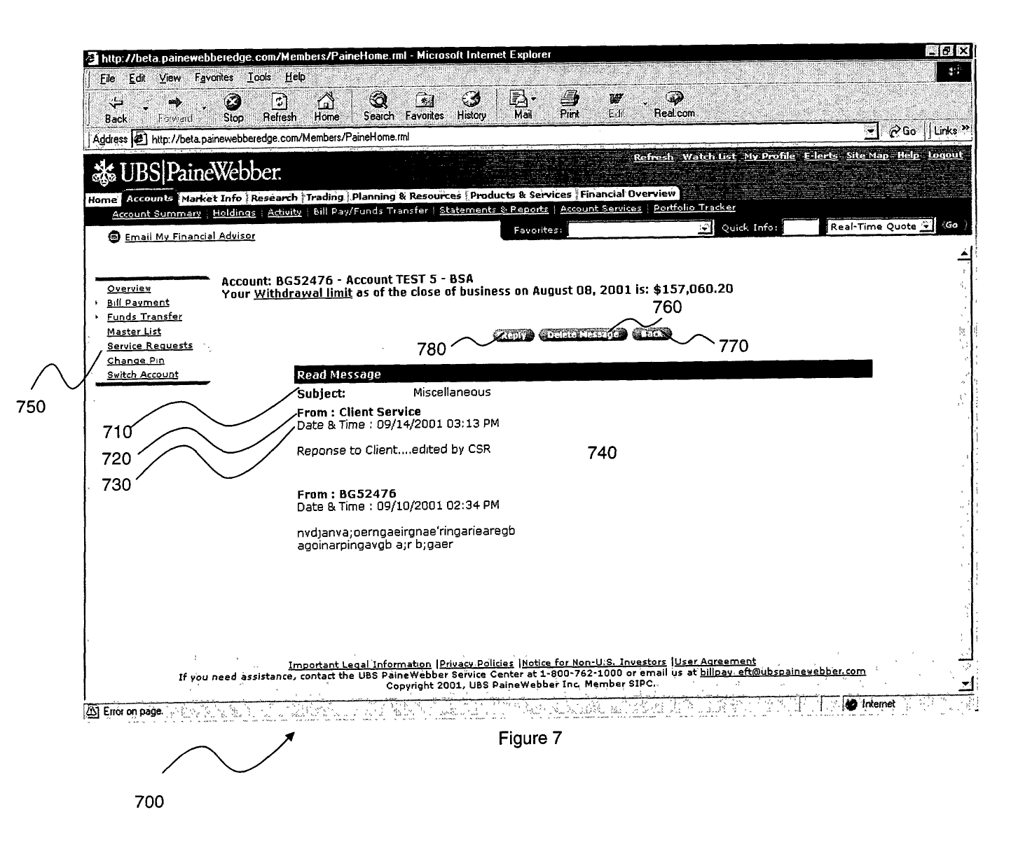

FIG. 6 illustrates an example of the “Service Request/Client Service” Home page 600, which is where clients can view a list of their messages 610 including messages sent by them and new messages. While this page 600 is displayed, a client clicking on the “Service Requests/Client Service” Home link 620 triggers display of this same page. A client clicking on the subject links 630 associated with each message triggers display of the “Read Message” page (an example of which being illustrated in FIG. 7). If the subject link 630 is clicked for a new message, i.e., one that the client has not yet read, the status field changes from ‘new’ to ‘old’ and display of the “Service Requests/Client Service Home” page is triggered including this update.

A client clicking on the delete link for each message launches a pop-up message. When the client clicks the “Deletc” link 640 in the action column, display of a pop-up message is triggered that displays a specialized message depending on the status of the message being deleted (e.g., “new”, “old”, or “sent”). In response to the display of one of these pop up messages, the client can click on an “OK” icon to proceed or a “Cancel” icon to maintain display of the currently displayed page. Examples of text associated with each of the pop up messages include: New—“You are about to delete a response that you have not read. Are you sure you want to proceed?”; Sent—“You are about to delete a message that you sent. If you proceed you will not receive a response. Are you sure you want to proceed?”; and Old—“If you delete this message, you will not be able to read it in the future. Are you sure you want to proceed?”.

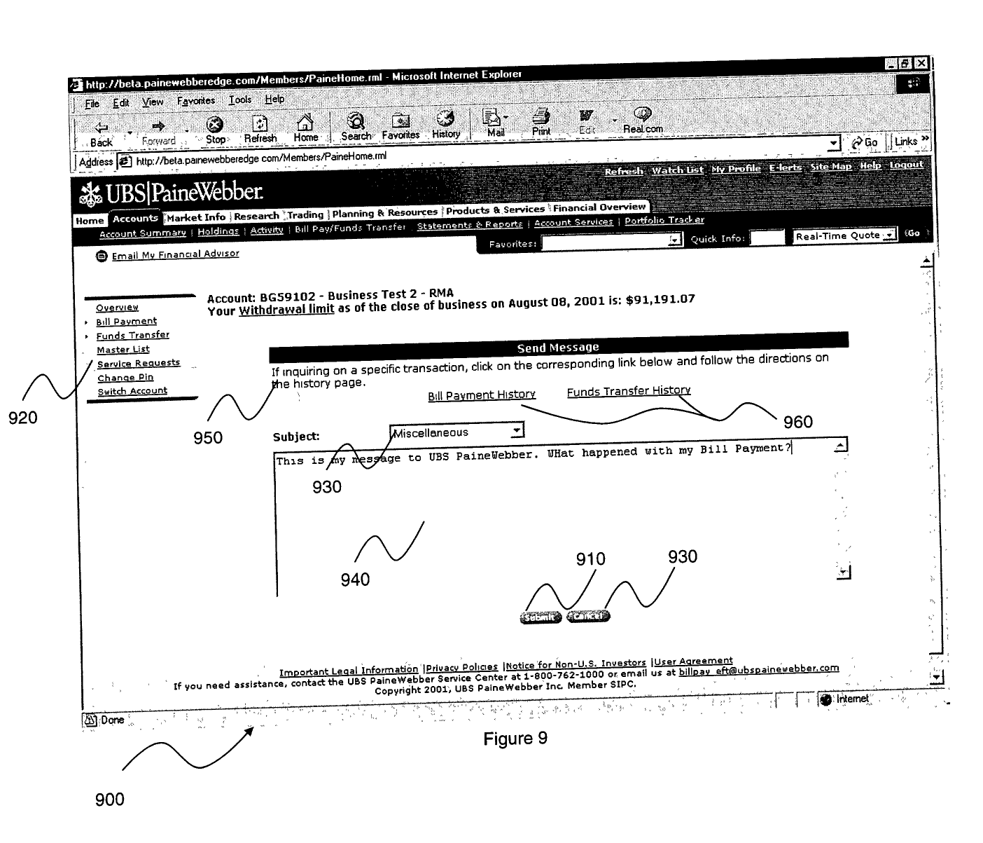

A client clicking on the “Send New Message” button 650 triggers display of a “Send Message” page (an example of which being illustrated in FIG. 9) When the client receives a response from the system to a message that they sent, the message status may change to “New” from “Sent”. A client clicking on a particular message will trigger display of the response from the system on the “Read Message” page (an example of which being illustrated in FIG. 7). “Sent” messages may be updated to “Old” by the system. “New” messages may also display the date the message arrives; “Sent” messages may also display the date the client sent the message and “old” messages may also display the date the message arrived. Messages may be sorted, for example, with “New” at the top, followed by “Sent”, then “Old”. Within each category, messages also may be sorted with the newest message at the top and the oldest at the bottom.

FIG. 7 illustrates an example of a “Read Message” page 700, which is the page where a client may view a specific message. This page will display the text of messages sent to the client from the system or organization personnel associated with the system or messages the client sent to either the system or organization personnel. Information fields displayed on the “Read” page may be displayed in various orders, for example, in the following order: subject 710, details for transaction (not shown), from 720, date and time of message 730, and text of individual messages 740. The “from” address field 720 for messages sent to the client from the system or an organization associated with the system may indicate this appropriately, e.g., reading “Client Service”. While this page 700 is displayed, a client clicking on the service requests link 750 will trigger display of the “Service Request/Client Service Home” page (an example of which being illustrated in FIG. 6).

A client clicking on the “Delete Message” button 760 will trigger launching of a pop up window. Within the pop up window, if the client selects a “Yes” option, display of the “Service Request/Client Service Home” page will be triggered. When the client clicks on the “Delete” button, a pop-up message may be launched that will display a different message depending on the status of the message being deleted (e.g., “Old” or “Sent” may have two different associated pop-up messages). The client can click on an “OK” icon to proceed and a “Cancel” icon to remain on the current page. Examples of text for each message is as follows: Sent—“You are about to delete a message that you sent. If you proceed you will not receive a response. Are you sure you want to proceed?” and Old—If you delete this message, you will not be able to read it in the future. Are you sure you want to proceed?”.

If a client message with a status of “Sent” is updated to “No Response Required” by an administrator of the system or personnel acting as an agent of the client, the message status may be changed from “Sent” to “Old” on the “Service Request/Client Service” Home page (an example of which being illustrated in FIG. 6). The last message in a thread of messages may contain text that reads “Your message required no response” and may be date stamped with the time an administrator of the system or personnel acting as all agent of the client updated the status to “Old”.

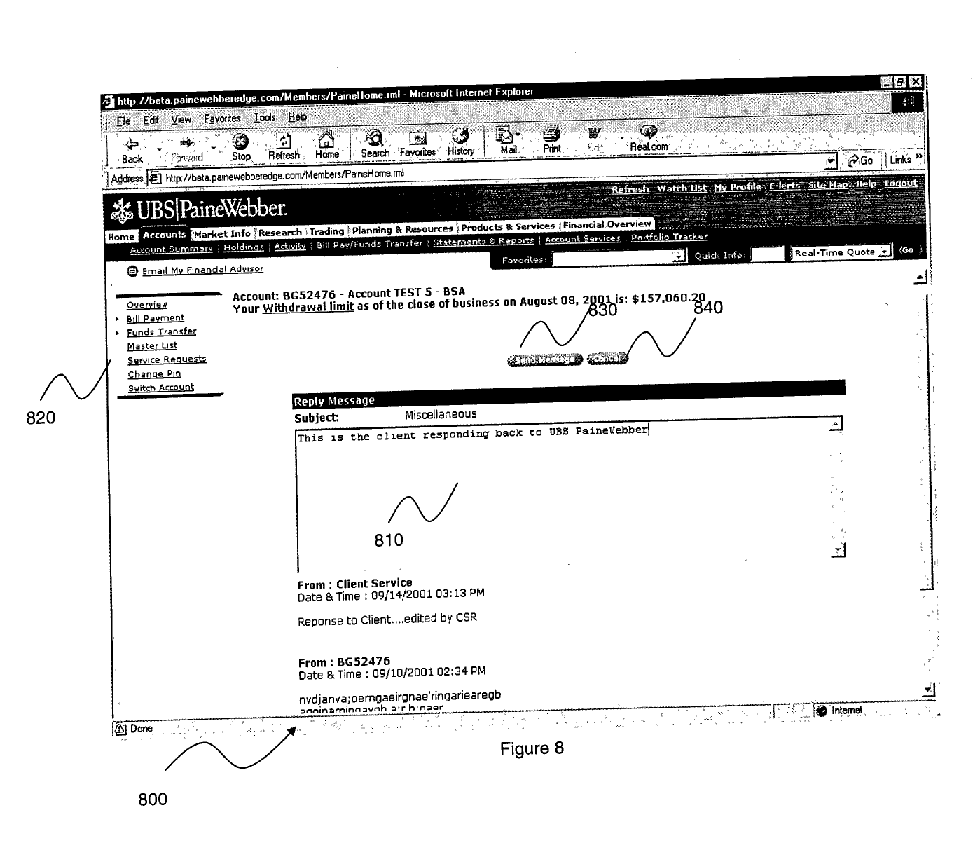

A client clicking on the “Back” button 770 will trigger display of the “Service Request/Client Service Home” page. A client clicking on the “Reply” button 780 will trigger display of a “Follow Up Message” page (an example of which being illustrated in FIG. 8). When the “Reply” button 780 is clicked on, an existing message thread and related details of the currently viewed message will be passed to the next screen for viewing. The “Reply” button 780 may only appear if the message is sent to the client from the system or an organization associated with the system and is not a global message (i.e., one sent to all clients); thus, clients may not be allowed to reply to a global message. Also, the “Reply” button 780 may not appear if the client is reading a message they sent to the system or organization personnel associated with the system.

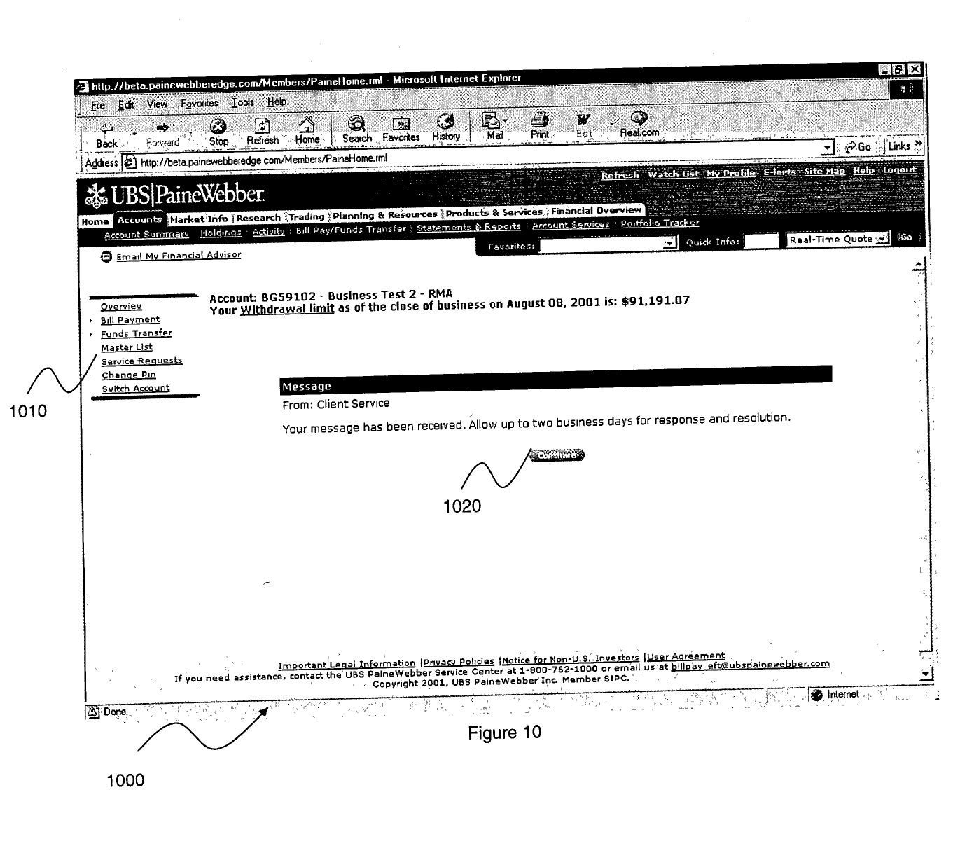

FIG. 8 illustrates an example of the “Follow Up Message” page 800, which is used to allow clients to respond to messages from the system and/or an organization associated with the system by composing a follow-up message in the message field 810. While the page 800 is displayed, a client clicking on the “Service Requests/Client Service” link 820 will trigger display of the “Service Requests/Client Service” Home page (an example of which being illustrated in FIG. 6). A client clicking on the “Send Message” button 830 will trigger display of a “Send Confirmation” page (an example of which being illustrated in FIG. 10). A client clicking on the “Cancel” button 840 will trigger display of the Service Requests/Client Service” Home page.

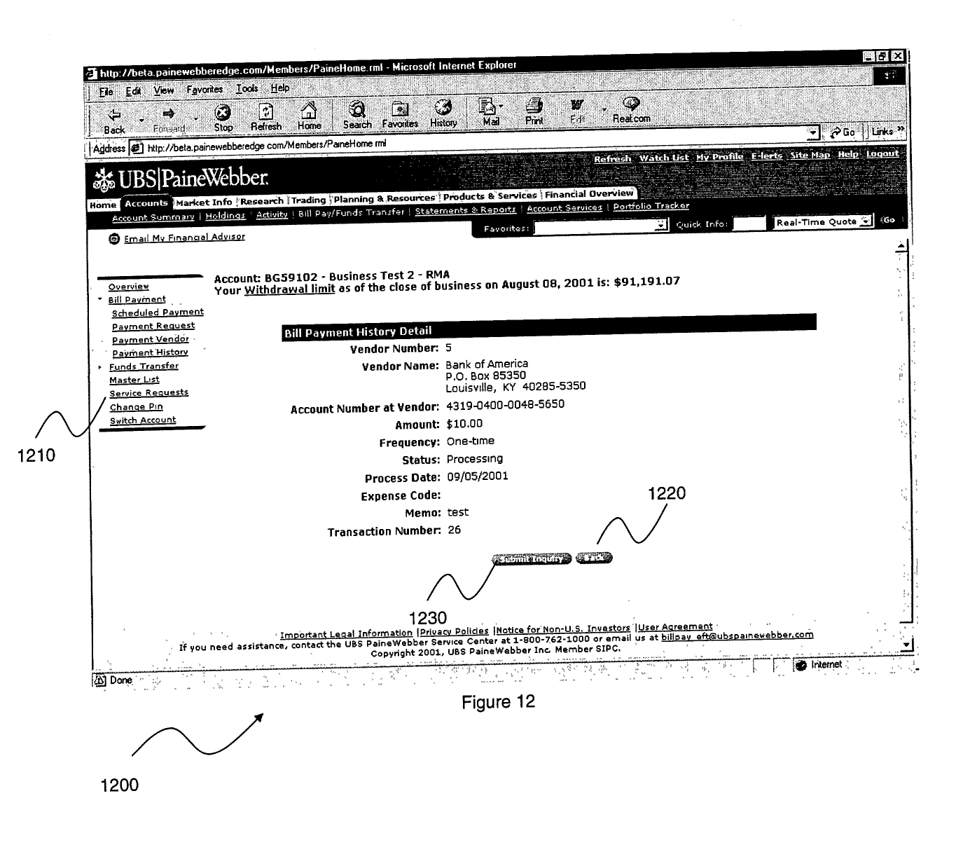

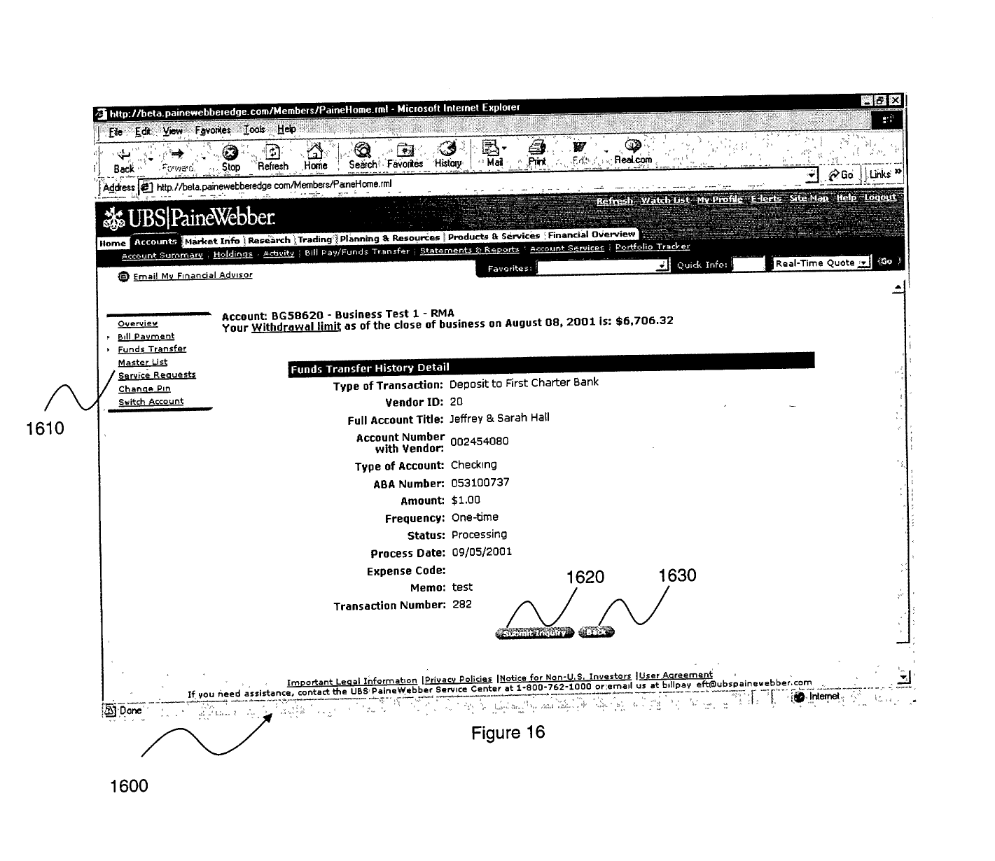

Various information may be displayed for each message in various orders including the order of, for example, Subject (default to subject of message being replied to), details for an associated transaction if the client most recently viewed a “History Details” page (examples of which being illustrated in FIGS. 12 and 16), and messages (all messages may include information indicating whom the message is from, the date and time the message was sent and the text of the message).

FIG. 9 illustrates an example of the “Send Message” page 900, which is where a client can submit a new message to the system or organization personnel associated with the system. Once the client has triggered submission of the message by clicking on the “Submit” button 910, the message may first be sent to a system administrator or agent acting on behalf of the client and then forwarded to the system or appropriate organization personnel.

While the “Send Message” page 900 is displayed, a client clicking on the “Service Requests/Client Service” link 920 will trigger display of the “Service Requests/Client Service” Home page (an example of which being illustrated in FIG. 6). A client clicking on the “Submit” button 910 will trigger display of a “Send Confirmation” page (an example of which being illustrated in FIG. 10). A client clicking on the “Cancel” button 930 will trigger display of the “Service Requests/Client Service” Home page.

Various navigation choices are available to the client on page 900 by the client clicking on the “Subject” pull down bar 930, e.g., “Bill Payment Inquiry”, “Funds Transfer Inquiry”, “System Issue”, “Miscellaneous”, and “Suggestion”. The client can also add text to the message in the text field 940. When the client clicks on the “Submit” icon 910, the message is sent to the system, financial services organization personnel, or, as mentioned above, an administrator or agent acting on behalf of the client.

Instructional text 950 at the top of page may provide direction to the client on how to use the fields and icons displayed on the page. Two links 960 may also be included at the top of the page (e.g., below the text and above the text field) that read “Bill Payment History” and “Funds Transfer History”. When these links are clicked on by the client, the “Bill Payment History Summary” page (an example of which being illustrated in FIG. 11) and the “Funds Transfer History Summary” page (an example of which being illustrated in FIG. 15) may be displayed respectively depending on the clicked link.

If the client attempts to submit a message and has not selected a “Subject”, a message may pop up reading “The following errors have occurred: Subject—is a mandatory field”. The client may not then be able to submit the message until the “Subject” has been selected.

FIG. 10 illustrates an example of the “Send Confirmation” page 1000, which is where a client receives confirmation that his/her request was sent to the system and/or organization personnel associated with the system. Text displayed on this page may be specific to the subject identified by the client for the message. While this page is displayed, a client clicking on the “Service Request/Client Service” link 1010 or the “Continue” button 1020 will trigger display of the “Service Request/Client Service Home” page (see example at FIG. 6).

FIG. 11 illustrates an example of the “Bill Payment History Summary” page 1100, which displays bill payment history details associated with bill payment services provided by the system and/or a financial services organization associated with the system. Instructional text 1110 may appear on this page that indicates how to send a message with transaction details. A client clicking on the “Service Request/Client Services” link will trigger display of the “Service Request/Client Service Home” page (an example of which being illustrated in FIG. 6). While the page 1110 displayed, the client can click on the “Vendor Name” links 1120 associated with each listed transaction to view details for a particular bill payment transaction on the “Bill Payment History Details” page.

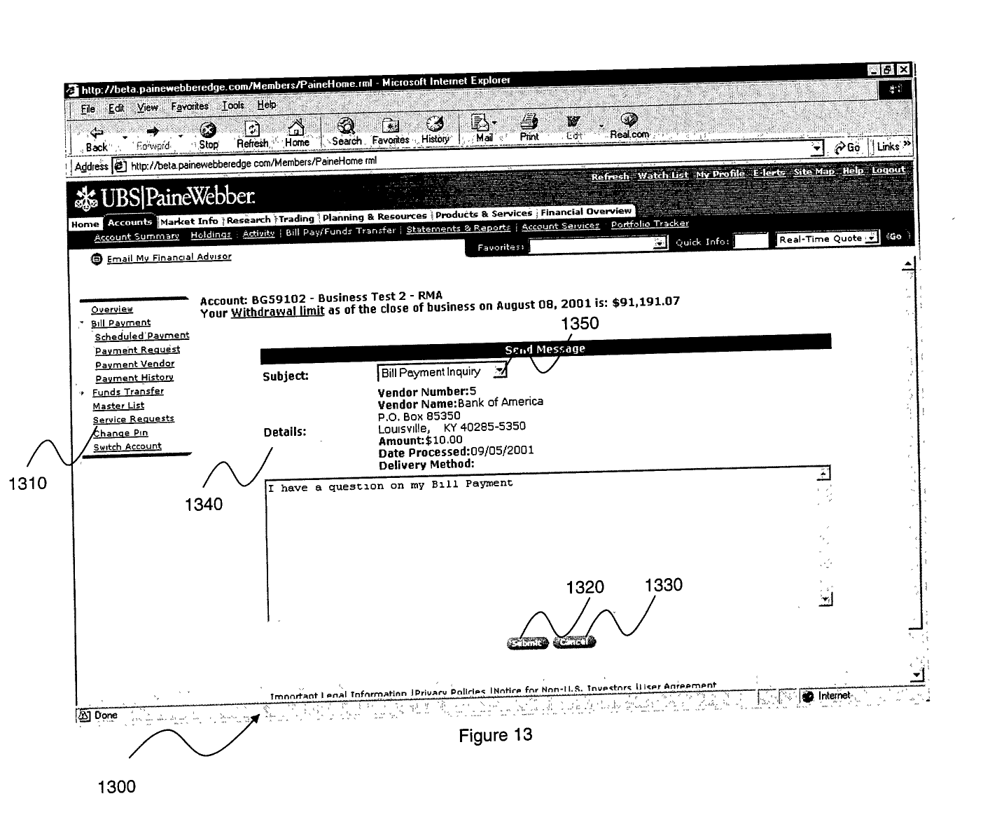

FIG. 12 illustrates an example of the “Bill Payment History Details” page 1200, which displays details associated with particular bill payment transactions. While the “Bill Payment History Details” page 1200 is displayed, a client clicking on the “Service Requests/Client Services” link 1210 will trigger display of the “Service Request/Client Service Home” page (an example of which being illustrated in FIG. 6). A client clicking on the “Back” button 1220 will trigger display of the “Bill Payment History Summary” page (an example of which being illustrated in FIG. 11). From that “Bill Payment History Details” page 1200, the client can also send a new message to the system and/or an organization associated with the system. For example, by clicking on the “Submit Inquiry” button 1230, the client can trigger display of the “Bill Payment History Inquiry” page (an example of which being illustrated in FIG. 13). Clicking on the “Submit inquiry” link 1230 triggers export of transaction details associated with the bill payment transaction last displayed on the “Bill Payment History Details” page 1200.

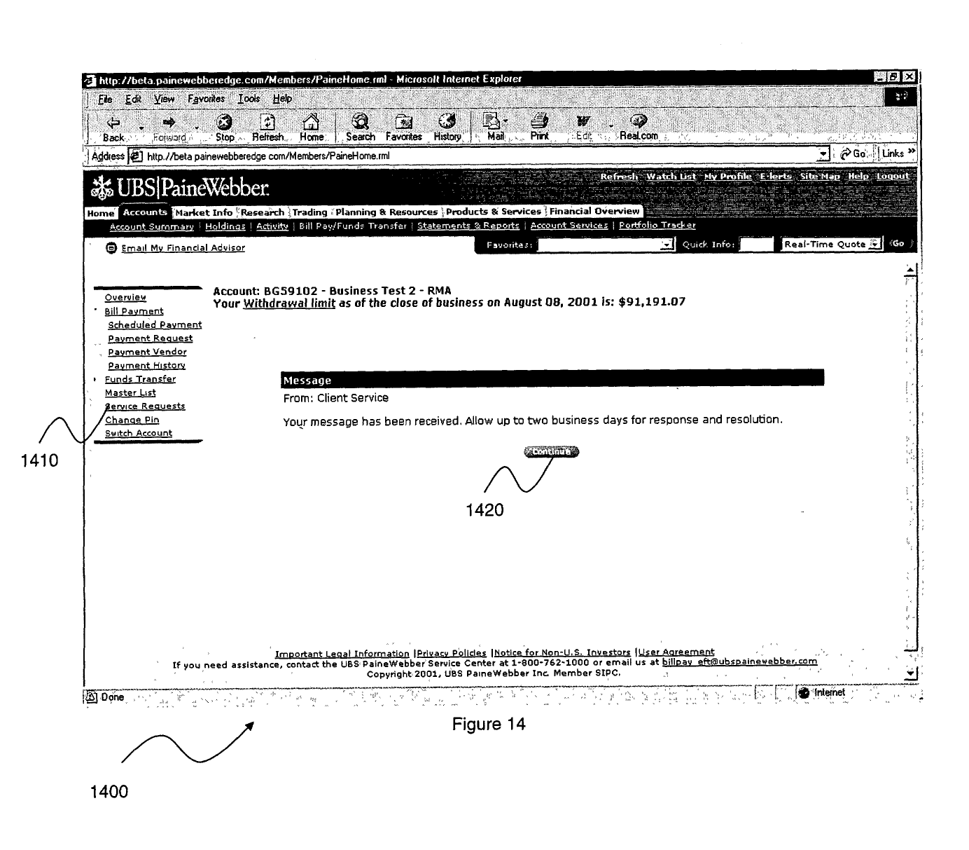

FIG. 13 illustrates an example of the “Bill Payment History Inquiry” page 1300, which, as explained above, may be pre-populated with transaction information from the “Bill Payment History Detail” page 1200 of FIG. 12. While the “Bill Payment History Inquiry” page 1300 is displayed, a client clicking on the “Service Requests/Client Service” link 1310 triggers display of the “Service Request/Client Service Home” page (an example of which being illustrated in FIG. 6). A client clicking on the “Submit” button 1320 will trigger display of a “Bill Payment History Inquiry Confirmation” page (an example of which being illustrated in FIG. 14). A client clicking on the “Cancel” button 1330 triggers display of the “Bill Payment History Summary” page (an example of which being illustrated in FIG. 11).

The “Details” section 1340 contains information from the most immediately previously displayed “Bill Payment History Detail” page 1200 of FIG. 12. Potential inquiry subjects 1350 include “Bill Payment Inquiry” and “Miscellaneous”, additionally “Stop a Check” may also be an option if the particular bill payment transaction has a delivery method of “Check”. Fields required for the “Details” may include: Vendor Name, Vendor Number, Amount, Date Processed, Delivery Method, Payment ID (if the specified delivery method associated with the particular bill payment transaction is “Check”).

When a client clicks on the “Submit Inquiry” icon 1320 for a particular bill payment transaction, the “Bill Payment History Inquiry Confirmation” page (an example of which being illustrated in FIG. 14 as page 1400) will be displayed. This page 1400 indicates confirmation that a previously submitted bill payment history inquiry message was received by the system and/or organization personnel associated with the system. The text for this page may differ depending upon the “Subject” of the message being sent. While the “Bill Payment History Inquiry Confirmation” page is displayed, a client clicking on the “Service Requests/Client Service” link 1410 triggers display of the “Service Requests/Client Service Home” page (see FIG. 6 for an example). A client clicking on the “Continue” button 1420 triggers display of the “Bill Payment History Summary” page (an example of which being illustrated in FIG. 11).

FIG. 15 illustrates an example of a “Funds Transfer History Summary” page 1500, which may display details associated with one or more funds transfer transactions. The display of this page 1500 may be triggered by a client clicking on a “Vendor Name” to view details of a funds transfer while another page is displayed. While this page 1500 is displayed, a client clicking on the “Service Requests/Client Service” link 1510 will trigger display of the “Service Requests/Client Service Home” page (see the example illustrated in FIG. 6). A client clicking on the “Vendor Name” link 1520 associated with a particular funds transfer transaction will trigger display of a “Funds Transfer History Details” page (an example of which being illustrated in FIG. 16), at which a client can send a message regarding the funds transfer history. The “Funds Transfer History Summary” page 1500 may allow a client to search for various electronic funds transfers over a specified period of time by entering a range of time by indicating the beginning and end period of the range in the “From” and “To” fields 1550. Additionally, the client can search electronic funds transfers, or bill payment transactions, by various criteria, including vendor name, vendor number, amount, date processed, status, etc., by selecting the criteria in the “Search By” field 1540. The “Funds Transfer History Summary” page 1500 may also include instructions 1530 on how to send a message.

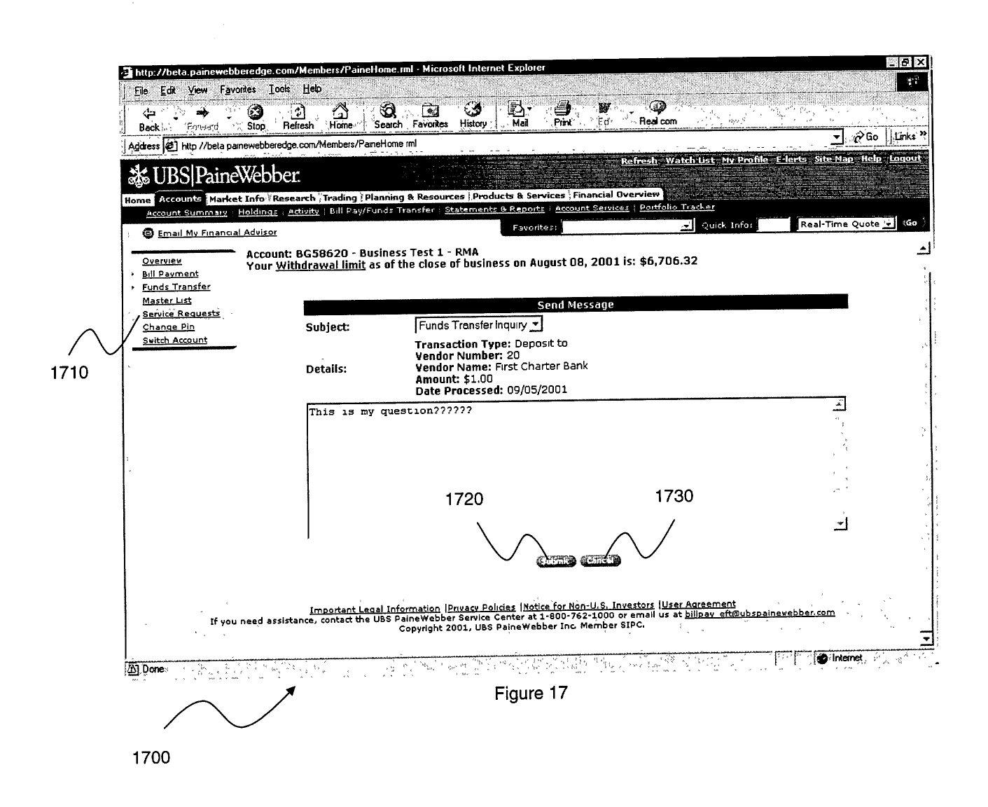

FIG. 16 illustrates an example of the “Funds Transfer History Details” page 1600. Such a page 1600 allows the client to send a message to the system and/or an organization associated with the system that includes funds transfer transaction details. While this page 1600 is displayed, a client clicking on the “Service Requests/Client Service” link 1610 will trigger display of the “Service Requests/Client Service Home” page (see FIG. 6 for an example). A client clicking on the “Submit Inquiry” button 1620 will trigger display of an “Funds Transfer History Inquiry” page (an example of which being illustrated in FIG. 17). A client clicking on the “Submit Inquiry” button 620 will also trigger display of the details for the particular transaction displayed on the “Funds Transfer History Detail” page 1600 on a next page (e.g., the “Funds Transfer History Inquiry” page). A client clicking on the “Back” button 1630 may trigger display of the “Funds Transfer History Summary” page (an example of which being illustrated in FIG. 15).

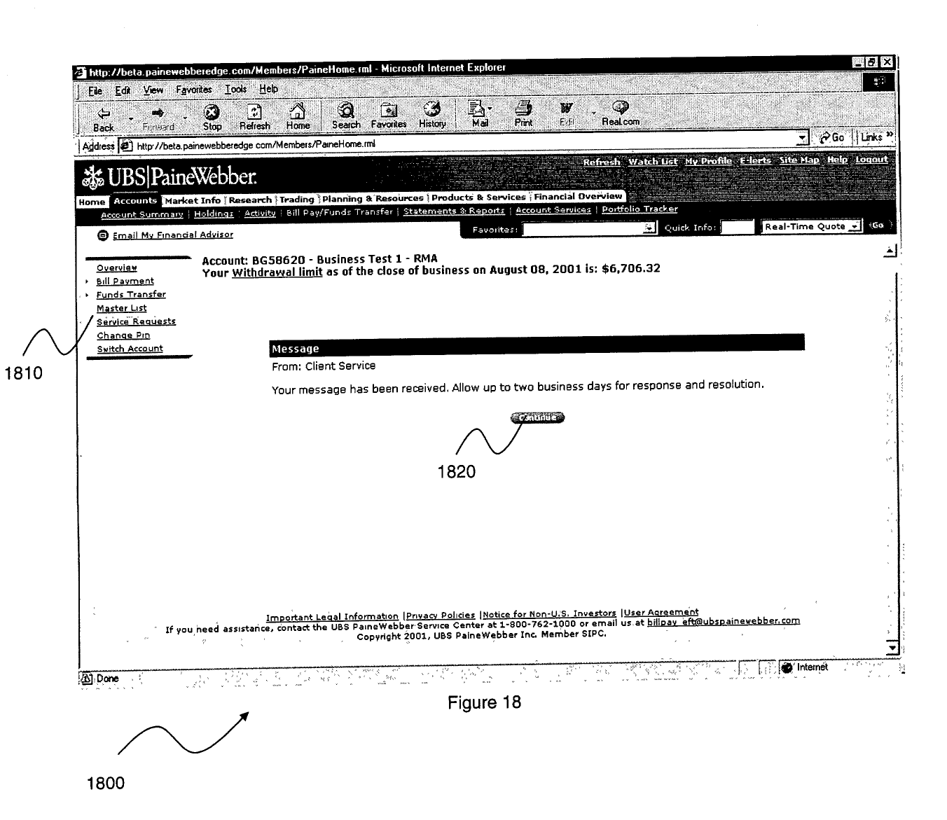

FIG. 17 illustrates an example of the “Funds Transfer History Inquiry” page 1700. As explained above, this page 1700 may be pre-populated with electronic funds transfer transaction information displayed on the most proximate previously displayed “Fund Transfer History Details” page (an example of which being illustrated in FIG. 16). While the “Funds Transfer History Inquiry” page is displayed, a client clicking on the “Service Requests/Client Service” link 1710 will trigger display of the “Service Requests/Client Service Home” page (see FIG. 6 for an example). A client clicking on the “Submit” button 1720 triggers display of a “Funds Transfer History Inquiry Confirmation” page (an example of which being illustrated in FIG. 18). Clicking on the “Cancel” button 1730 triggers display of the “Funds Transfer History Summary” page (an example of which being illustrated in FIG. 15). Possible subjects for the inquiry include “Funds Transfer Inquiry” and “Miscellaneous”. Required fields for the inquiry may include: Transaction Type, Vendor Name, Vendor Number, Amount, and Process Date.

FIG. 18 illustrates an example of the “Funds Transfer History Inquiry Confirmation” page 1800, which is the page that confirms that a previously submitted funds transfer history inquiry message was received by the system and/or organization personnel associated with the system. The text for this page 1800 may differ depending upon the “Subject” of the message being sent. While this page is displayed, a client clicking on the “Service Requests/Client Service” 1810 link will display the “Service Requests/Client Service Home” page (see FIG. 6). A client clicking on the “Continue” button 1820 triggers display of the “Electronic Funds Transfer History Summary” page (an example of which being illustrated in FIG. 15).

It should be appreciated that, although not described in great detail, various other links, buttons, data and functionality is available on the various pages associated with the system (examples of which being illustrated in FIGS. 5-18). For example, as illustrated in various figures, a withdrawal limit may be displayed to the client.

Additionally, the functionality described above may be included in a system that provides various information and data to clients of a financial services organization associated with the system. For example, some or all of the pages may include links to a master home page associated with the system, financial market information, financial market research tools, planning and resources information and tools, details regarding the products and services provided by the financial services organization, one or more pages indicating an overview of a client's financial portfolio, etc. Additionally, along with reviewing and replying to messages associated with various financial services transactions, a client may view additional information on pages indicating, for example, an account summary for the client, details associated with the client's holdings and activities, statements and reports pertaining to or associated with the client, account services being utilized by the client, a portfolio tracking tool that monitors the status of the client's portfolio, etc. Further, Such pages may include links to real-time quotes for financial instruments markets as well as links to various administrative tools for the client, e.g., one or more pages associated with changing a password or pin number, etc. Moreover, while a client is viewing pages associated with one of his/her accounts, a link may be provided that allows the client to switch to viewing data associated with other of his/her accounts.

As explained above, in accordance with at least one embodiment of the invention, clients of the organization using the organization's financial services will receive automated service request messages from the system triggered by different events that occur for the client's account. Various events may trigger transmission of an automated message.

For example, the addition of pending vendors may trigger one or more automated messages. More particularly, clients that add electronic funds transfer vendor information online may be required to print a .pdf form, sign it, and send it to the system and/or an organization associated with the system to have the vendors activated for funds transfers. If the system and/or organization associated with the system, has not received the form from the client after some period of time, e.g., two weeks, the system and/or the organization associated with the system may send the client an automated message indicating the continued need their signed form. Clients may receive another automated message as a reminder if the system and/or organization associated with the system have not received the signed form within an extended time period, e.g., four weeks.

Similarly, the identification of an aged check may trigger one or more automated message. More particularly, clients that have bill payments processed as checks (rather than as electronic payments) and that still have not cleared after some specified period of time, e.g., thirty days, will receive an automated message informing them that their check is still outstanding. Clients may also be sent a second automated message within an extended time period, e.g., forty-five days, if the check remains outstanding.

Further, the occurrence of a final transaction may trigger one or more automated messages. More particularly, clients with final recurring transactions (e.g. bill payments, electronic funds transfers, etc.) effecting their account(s) may be sent a message reminding them that the transaction is final. These messages may be sent after the next to the last transaction is processed. For example, if a client has a recurring monthly bill pay scheduled to run on the first of every month and expiring Jul. 1, 2002, the client will receive a message on the night of Jun. 1, 2002 indicating that this is the final authorized payment and potentially indicating instructions for reauthorizing the transaction for an additional period of time.

A transaction cancellation may trigger transmission of one or more automated messages. For example, clients may be sent an automated message when bill payments or electronic funds transfers are cancelled and the funds are returned to the client's account. Similarly, stops and reissues of checks for a client's account may trigger transmission of at least one automated message to the client.

Please see the attached Appendix, which provides additional details with regard to the above-described examples of automated messages that may be generated by the system as well as additional examples of such automated messages.

These automated messages may be displayed to the client when the client views the “Service Request/Client Service” Home page (see the example of FIG. 6) and associated pages that provide the full text of messages (see, for example, the example illustrated in FIG. 7). Additionally, after reviewing the automated message, a client can generate a reply message (by clicking on the “Reply” icon associated with the message). Such a reply message can automatically retain all or some portion of the detail information provided by the automated message.

As explained above, the client may be receiving and sending messages to personnel associated with an organization operating the system or otherwise associated with the system. In order to facilitate identification of potential issues associated with a client's account or to facilitate proper processing of transactions requested by a client, such personnel may also log onto the system as administrators of the system and/or agents of the client and subsequently click on the “Service Requests/Client Service” links provided on various pages provided by the system.

Provided that these personnel have been granted requisite authority by their organization and/or a particular client, such personnel can view all client messages requiring a response. Various safeguards may be built into the system to ensure that only one personnel member is acting on behalf of the client to resolve any given issue for example, once particular personnel clicks on a “Reply” icon associated with a particular message displayed on a page, the system may prevent other organization personnel from responding to that particular message.

Additionally, in accordance with at least one embodiment of the invention, organization personnel may draft all responses to client inquiries and responses. When a draft response is complete, the personnel may send it directly to the client or forward the draft message to other personnel within the organization associated with the system. A record of all messages may be included on a “Message Search” page (not shown) available for viewing by organization personnel. This page may also display the date and time the message was sent by the client and the date and time the response was drafted and sent to various organization personnel.

While this invention has been described in conjunction with the specific embodiments outlines above, it is evident that many alternatives, modifications and variations will be apparent to those skilled in the art. Accordingly, the embodiments of the invention, as set forth above, are intended to be illustrative, not limiting. Various changes may be made without departing from the spirit and scope of the invention.

What is claimed is:

1. A system that provides at least one financial service to at least one client, the system comprising:
at least one server running software that is configured to operate based on instructions provided by the client to facilitate at least one financial service transaction, the software further being configured to monitor processing of the transaction and record data associated with the transaction and the transaction's processing, the software analyzing the monitored processing and proactively generating an automated message to the at least one client if the monitoring of the transaction processing indicates a potential problem with completing the financial services transaction.

2. The system of claim 1, wherein the automated message includes details indicating the at least one financial service transaction and the potential problem in completing the at least one financial services transaction.

3. The system of claim 1, wherein the software if further configured to receive a reply to the automated message from the at least one client, the reply including pre-populated details indicating the at least one financial service transaction included in the automated message.

4. The system of claim 1, wherein the at least one financial service transaction is an electronic funds transfer transaction.

5. The system of claim 4, wherein the electronic funds transfer transaction is a repetitive transfer transaction and a time period authorized for performing the repetitive transfer transaction has expired.

6. The system of claim 1, wherein the at least one financial service transaction is a electronic bill payment transaction.

7. The system of claim 1, wherein the at least one financial service transaction is an addition of a new vendor to transact electronic funds transfers to or from.

8. The system of claim 1, wherein the at least one financial service transaction is a check payment.

9. The system of claim 1, wherein the at least one server supports display of one or more pages of data specific to the at least one client and including any automated messages (generated by the system.

10. The system of claim 9, wherein the one or more pages are configured to enable that at least one client to review automated messages and generate replies to the automated messages and transmit the generated automated messages.

11. A method for expediting at least one financial service to at least one client, the method comprising:
monitoring processing of at least one financial service transaction for at least one client;
recording data associated with the transaction and the transaction's processing;
analyzing the monitored processing to identify potential problems in the processing; and
proactively generating an automated message to the at least one client if the monitoring of the transaction processing indicates a potential problem with completing the financial services transaction.

12. The method of claim 11, wherein the automated message includes details indicating the at least one financial service transaction and the potential problem in completing the at least one financial services transaction.

13. The method of claim 11, further comprising receiving a reply to the automated message from the at least one client, the reply including pre-populated details indicating the at least one financial service transaction included in the automated message.

14. The method of claim 11, wherein the at least one financial service transaction is an electronic funds transfer transaction.

15. The method of claim 14, wherein the electronic funds transfer transaction is a repetitive transfer transaction and a time period authorized for performing the repetitive transfer transaction has expired.

16. The method of claim 11, wherein the at least one financial service transaction is a electronic bill payment transaction.

17. The method of claim 1 wherein the at least one financial service transaction is an addition of a new vendor to transact electronic funds transfers to or from.

18. The method of claim 11, wherein the at least one financial service transaction is a check payment.

19. The method of claim 11, further comprising displaying one or more pages of data specific to the at least one client and including any automated messages generated by the system.

20. The method of claim 19, wherein the one or more pages are configured to enable that at least one client to review automated messages and generate replies to the automated messages and transmit the generated automated messages.

21. One or more software programs stored in memory and accessible by one or more computers, the one or more software programs being configured to:
monitor processing of at least one financial service transaction for at least one client;
record data associated with the transaction and the transaction's processing;
analyze the monitored processing to identify potential problems in the processing; and
proactively generate an automated message to the at least one client if the monitoring of the transaction processing indicates a potential problem with completing the financial services transaction.
